(19) United States
(12) Patent Application Publication
(10) Pub. No.: US 2009/0075718 A1
(43) Pub. Date: Mar. 19, 2009

(54) Slot Machine Having A Bonus Game

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/206,863

(22) Filed: Sep. 9, 2008

(30) Foreign Application Priority Data
Sep. 13, 2007 (JP) JP2007-237462

(51) Int. Cl. A63F 9/24; A63F 13/00

(52) U.S. Cl. 463/20

(57) ABSTRACT

Symbols which are handled as specified targets of a pay line L, from amongst symbols which are rearranged through window displays W1, W2 and W3 which are in a transparent state in a liquid crystal panel 5B, may include blanks. In this case, a [FRANKENSTEIN] symbol which is not drawn on the reel bands of reels R1, R2 and R3 may be respectively displayed on the respective display windows W1, W2 and W3 which are in a transparent state, over these blanks. These [FRANKENSTEIN] symbols migrate from inside the respective display windows W1, W2 and W3 in the liquid crystal panel 5B to outside and under these display windows W1, W2 and W3, where they are displayed. In this case, the [FRANKENSTEIN] symbols become the symbols which are handled as specified targets of the pay line L, in place of the blanks, causing a bonus game trigger.

### CROSS-REFERENCE TO RELATED APPLICATIONS

This application is based upon and claims a priority from the prior Japanese Patent Application No. 2007-237462 filed on Sep. 13, 2007, the entire contents of which are incorporated herein by reference.

### BACKGROUND

1. Field

The present invention relates to a slot machine having a bonus game.

2. Description of Related Art

Conventionally, bonus game triggers for slot machines have broadly been classified into two types, including symbol-driven triggers and mystery triggers.

With respect to symbol-driven triggers, if a winning combination constituted solely of trigger symbols has been repositioned in a unit game, a predetermined payout is awarded to the player and at the same time, a bonus game is awarded right after that unit game. The probability of a winning combination constituted solely of trigger symbols being rearranged in the unit game is a constant value.

With respect to the mystery triggers, a bonus game is awarded right after the unit game, with a constant probability value, irrespective of the symbol combination that was repositioned in the unit game.

The following documents are given as prior art literature with respect to conventional game machines: U.S. Pat. No. 6,644,664B2; U.S. Pat. No. 6,634,941B2; US Patent Application Publication No. 2002/0025843A1; or AU Patent Publication No. 2001100267A4.

With respect to the former symbol-driven triggers, if a blank that has no relationship whatsoever with the payout is included in the symbol combination, the player cannot have any expectations. Due to the configuration of the slot game, the number of trigger symbols arranged on the reels is extremely small, as compared to the number of the other symbols arranged on the reels. Accordingly, although the probability of the winning combination constituted solely of trigger symbols being rearranged in the unit game is a constant value, the player may feel that this probability is considerably lower than the constant value, due to the number of the respective symbols that have been arranged on the reels, and may experience anxiety (Why don't I get a bonus game?).

With respect to the latter mystery triggers, the player cannot see the bonus game trigger. Accordingly, even if the unit game is repeated, the player cannot experience the process of getting close to the probability value at which the bonus game is awarded, and may experience anxiety (Why don't I get a bonus game?).

### SUMMARY

The present invention has been worked out in view of the above-described problems and an object thereof is to provide an innovative slot machine which could not be successfully achieved in the prior art, characterized by increased reliability with respect to the bonus game triggers.

To achieve the object of the disclosure, there is provided a slot machine, comprising: mechanical reels wherein symbols and blanks are provided; a transparent-type liquid crystal display including transparent areas inside which the symbols or blanks of the mechanical reels are in a transparent state, said display being adapted to display a pay line across inside said transparent areas or across outside said transparent areas; and a processor which is programmed to control the mechanical reels and the transparent-type liquid crystal display and execute processes (a) through (e) as follows: (a) rotating and stopping the mechanical reels; (b) if blanks of the mechanical reels have been arranged on the pay line when the mechanical reels are in a stopped state, displaying symbols inside said transparent areas of the transparent-type liquid crystal display so as to overlap the blanks; (c) if a predetermined number of trigger symbols, from the symbols which have been displayed inside said transparent areas of the transparent-type liquid crystal display, are arranged on the pay line, displaying 2 video reels outside said transparent areas of the transparent-type liquid crystal display for identifying a rotation number of times and a payout magnification rate; (d) displaying the video reels in a rotating manner and in a stopped manner; and (e) conducting a free game using the mechanical reels, based on said rotation number of times and payout magnification rate that were identified by displaying the video reels in a stopped state.

Furthermore, according to another aspect, there is provided a slot machine, comprising: mechanical reels wherein symbols and blanks are provided; a transparent-type liquid crystal display including transparent areas inside which the symbols or blanks of the mechanical reels are in a transparent state, said display being adapted to display a pay line across inside said transparent areas or across outside said transparent areas; and a processor which is programmed to control the mechanical reels and the transparent-type liquid crystal display and execute processes (a) through (e) as follows: (a) rotating and stopping the mechanical reels; (b-1) if blanks of the mechanical reels have been arranged on the pay line when the mechanical reels are in a stopped state, displaying symbols inside said transparent areas of the transparent-type liquid crystal display so as to overlap the blanks; (b-2) awarding a payout to a player based on a symbol combination that was arranged on the pay line, the symbol combination consisting of symbols which are displayed inside said transparent areas of the transparent-type liquid crystal display and symbols of the mechanical reels; (c-1) if a predetermined number of trigger symbols, from the symbols which have been displayed inside said transparent areas of the transparent-type liquid crystal display, are arranged on the pay line, causing the trigger symbols to migrate from inside said transparent areas of the transparent-type liquid crystal display to outside said transparent areas, where they are displayed; (c-2) displaying 2 video reels outside said transparent areas of the transparent-type liquid crystal display for identifying a rotation number of times and a payout magnification rate; (d) displaying the video reels in a rotating manner and in a stopped manner; and (e) conducting a free game using the mechanical reels, based on said rotation number of times and payout magnification rate that were identified by displaying the video reels in a stopped state.

### BRIEF DESCRIPTION OF THE DRAWINGS

FIG. 1 is a view showing characteristics of a slot machine according to one embodiment of the present invention;

FIG. 2 is a perspective view of the slot machine;

FIG. 3 is a schematic view showing symbol columns drawn on each of reels;

FIG. 4 is a block diagram schematically showing an internal construction of entire slot machine;

FIG. 5 is a block diagram schematically showing an internal construction of a sub control board;

FIG. 6 is a payout table showing winning combinations and payout amounts thereof when a base game or a free game is executed;

FIG. 7 is a view showing an image example displayed on a liquid crystal panel;

FIG. 8 is a view showing an image example displayed on the liquid crystal panel;

FIG. 9 is a view showing correspondence relationships between symbols, which are displayed as specified targets of a pay line in respective display windows of the liquid crystal panel, and symbol numbers;

FIG. 10 is a view showing an image example displayed on the liquid crystal panel;

FIG. 11 is a view showing an image example displayed on the liquid crystal panel;

FIG. 12 is a flowchart of a main control program;

FIG. 13 is a flowchart of a main game process program;

FIG. 14 is a flowchart of a free game process program;

FIG. 15 is a view showing correspondence relationships between code numbers of a video reel and predetermined number of games for a free game;

FIG. 16 is a view showing correspondence relationships between code numbers of a video reel and predetermined multiple numbers for the free game.

### DETAILED DESCRIPTION

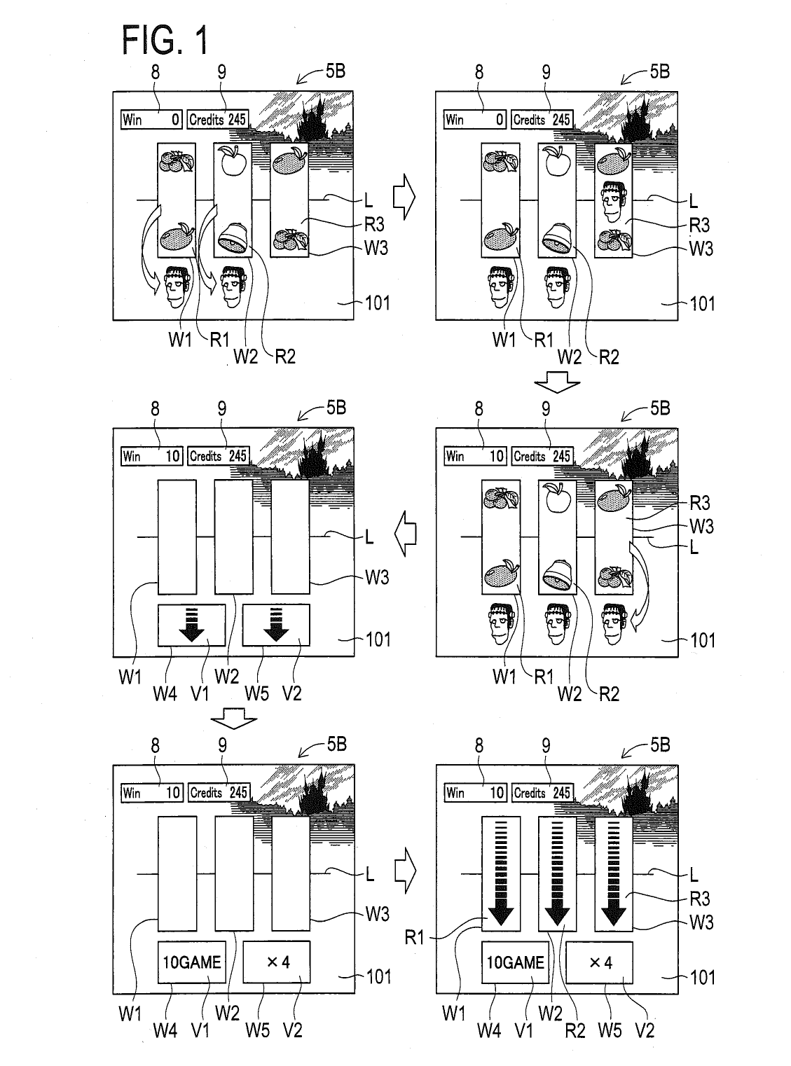

Hereinafter, the embodiment embodying the present invention is described with reference to the drawings. FIG. 1 is a view showing characteristics of a slot machine according to one embodiment of the present invention. When a liquid crystal panel 5B shown in FIG. 1 is specified, it is described by the No. of the stage from the uppermost stage of the figure.

The game conducted in the slot machine of the embodiment is constructed from two game modes of a base game and a bonus game.

In the base game, as shown in the picture at the left side in the first stage in FIG. 1, three symbols of each reel R1, R2, R3 are arranged through each of three display windows W1, W2, W3 which are made transparent, on the liquid crystal display panel 5B constructed from a well-known transparent liquid crystal display panel. A blank is included among the symbols of each reel R1, R2 and R3.

On the liquid crystal panel 5B, a pay line L, which crosses the three display windows W1, W2 and W3 horizontally, is displayed. The pay line L is used to specify the combination of the symbols. Furthermore, a payout amount display portion 8 and a credit amount display portion 9 are arranged on the liquid crystal panel 5B. In the liquid crystal panel 5B, areas of outside the respective display windows W1, W2 and W3 are in a non-transparent state. And in front of the liquid crystal panel 5B, a touch panel 101 is arranged.

Also, each of various winning combinations is determined in advance based on the symbol combination of the symbols. And based on the rotation and stop of each reel R1, R2 and R3, three symbols are rearranged through each display window W1, W2 and W3. Here, when the symbol combination constructed from the three symbols specified by the pay line L corresponds to any of the winning combinations, the payout amount corresponding to the winning combination is displayed on the payout amount display portion 8. Thereby, a unit game is formed. The payout amount displayed on the payout amount display portion 8 is added to the credit amount display portion 9 and is displayed, when the unit game is terminated. In other words, the base game is a so-called slot game.

If a symbol as a specified target on the pay line L, from amongst symbols which have been rearranged through the display window W1 of the liquid crystal panel 5B is a blank, a [FRANKENSTEIN] symbol which is not drawn on the reel band of reel R1 may be displayed on the display window W1 which is in transparent state, over that blank. Once the [FRANKENSTEIN] symbol is displayed, the [FRANKENSTEIN] symbol migrates from inside the display window W1 of the liquid crystal panel 5B to outside and under the display window W1, where it is displayed. The same thing happens in the case of display windows W2 and W3 in the liquid crystal panel 5B.

With respect to the picture at the left side in the first stage in FIG. 1, a blank, acting as a specified target of the pay line L, is respectively rearranged on the display windows W1 and W2 in the liquid crystal panel 5B. In this case, the [FRANKENSTEIN] symbols which are respectively displayed on the display windows W1 and W2, which are in a transparent state, over the respective blanks, migrate from inside the respective display windows W1 and W2 of the liquid crystal panel 5B to outside and under the respective display windows W1 and W2, where they are displayed. The migration and display of this [FRANKENSTEIN] symbol is first carried out with respect to the display window W1 in the liquid crystal panel 5B, and then, with respect to the display window W2 in the liquid crystal panel 5B.

Further, the picture at the left side in the first stage in FIG. 1 shows that a blank has been rearranged as a specified target symbol of the pay line L, through a display window W3 in the liquid crystal panel 5B. The picture at the right side in the first stage in FIG. 1 shows that a [FRANKENSTEIN] symbol which is not drawn on the reel band of reel R3 is displayed on the display window W3 which is in a transparent state, over that blank. Further, the picture at the right side in the second stage in FIG. 1 shows that the [FRANKENSTEIN] symbol which was displayed on the display window W3, which is in a transparent state, over that blank, migrates from inside the display window W3 of the liquid crystal panel 5B to outside and under the display window W, where it is displayed.

Then, as shown in the picture at the right side in the second stage in FIG. 1, display of the respective [FRANKENSTEIN] symbols outside and under the respective display windows W1, W2 and W3 of the liquid crystal panel 5B is handled as a bonus game trigger. In this case, a payout amount which was determined in advance is displayed on a payout amount display portion 8 and the game shifts to a free game which represents one type of bonus game. In the free game, a unit game corresponding to a base game is repeatedly carried out by a predetermined number of games (corresponding to [rotation number of times]). At this time, the payout amount which was awarded in the respective unit games is increased after being multiplied by a predetermined multiple number (corresponding to a [payout magnification ratio]), and is then displayed on the payout amount display portion 8. The predetermined number of games and the predetermined multiple number are determined and displayed after shifting to the free game.

And when the game shifts to the free game, as shown in the picture at the left side in the second stage in FIG. 1, the three display windows W1, W2 and W3 are first changed to a non-transparent state, thereby each of the reels R1, R2 and R3 becomes invisible to a player.

As shown in the picture at the left side in the second stage in FIG. 1, the [FRANKENSTEIN] symbols which have been respectively displayed outside and under the display windows W1, W2 and W3 in the liquid crystal panel 5B are erased. Then, two display windows W4 and W5 are displayed outside and under the respective display windows W1, W2 and W3 of the liquid crystal panel 5B. The display window W4 displays the rotating video reel V1 that displays a predetermined number of games for the free game. The display window W5 displays the rotating video reel V2 that displays a predetermined multiple number for the free game.

As shown in the picture at the left side in the third stage in FIG. 1, the display window W4 in the liquid crystal panel 5B displays the video reel V1 in a stopped state, thus displaying the predetermined number of games for the free game. The display window W5 in the liquid crystal panel 5B displays the video reel V2 in a stopped state, thus displaying the predetermined multiple number for the free game. In the liquid crystal panel 5B shown in the picture at the left side in the third stage in FIG. 1, a message reading [10GAME] is displayed on the display window W4, meaning that the predetermined number of games for the free game is 10, and a message reading [×4] is displayed on the display window W5, meaning that the predetermined multiple number for the free game is 4 times.

Then, as shown in the picture at the right side in the third stage in FIG. 1, the three display windows W1, W2 and W3 in the liquid crystal panel 5B return to a transparent state. This enables the player to see the respective reels R1, R2 and R3. Further, a first unit game from the unit games constituting the free game is started when the respective reels R1, R2 and R3 start rotating.

Hereinafter, the embodiment embodying the present invention will be described in detail with reference to the drawings.

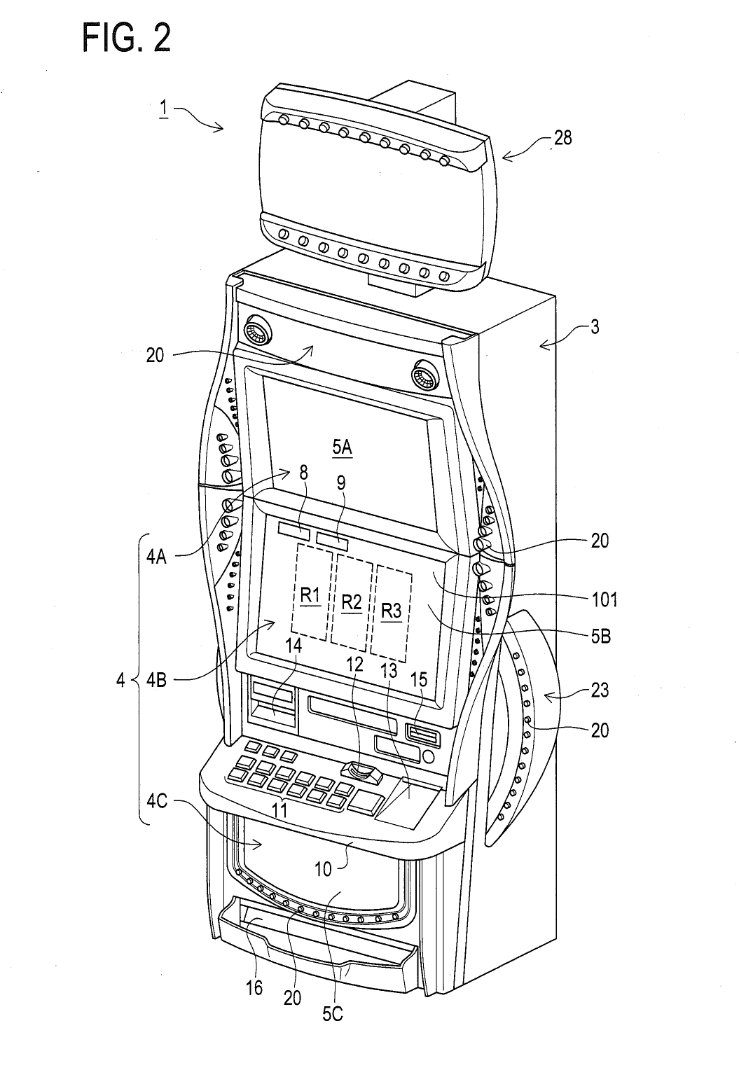

First, an outline construction of the slot machine 1 according to the embodiment is described with reference to FIG. 2. FIG. 2 is a perspective view of the slot machine 1 according to the embodiment.

As shown in FIG. 2, the slot machine 1 is an upright type gaming machine arranged in the game arcade such as casino, in order to execute predetermined game modes, such slot machine includes a cabinet 3 in which electronic and mechanical components are installed. For example, as a display portion 4 to display information concerning the game, there are provided an upper display portion 4A, a middle variable display portion 4B and a lower display portion 4C. Each display portion 4A to 4C is mounted at the front of the oblong cabinet 3. The upper display portion 4A includes a liquid crystal panel 5A which is arranged above the middle variable display portion 4B. On the liquid crystal panel 5A, for example, the effect image, the introduction of the game content, and the rule explanation of the game are displayed. The lower display portion 4C is arranged below the middle variable display portion 4B, and includes a plastic panel 5C on which the images are printed, and the plastic panel 5C is lightened by the backlights.

The middle variable display portion 4B, which is used to display the execution state of the game, includes the transparent liquid crystal panel 5B which is fixed at the front door of the cabinet 3. Through the liquid crystal panel 5B, the symbols of each reel R1, R2 and R3 arranged inside the cabinet 3, may be visible by the player. In the middle variable display portion 4B, one pay line L horizontally crossing each of areas corresponding to the reels R1, R1, R3 is displayed on the liquid crystal display panel 5B. On the upper position of the middle variable display portion 4B, the payout amount display portion 8 and the credit amount display portion 9 are arranged on the liquid crystal panel 5B. Also the upper portion of the middle variable display portion 4B, is related to the back side, thereby the player may play games in a cozy posture.

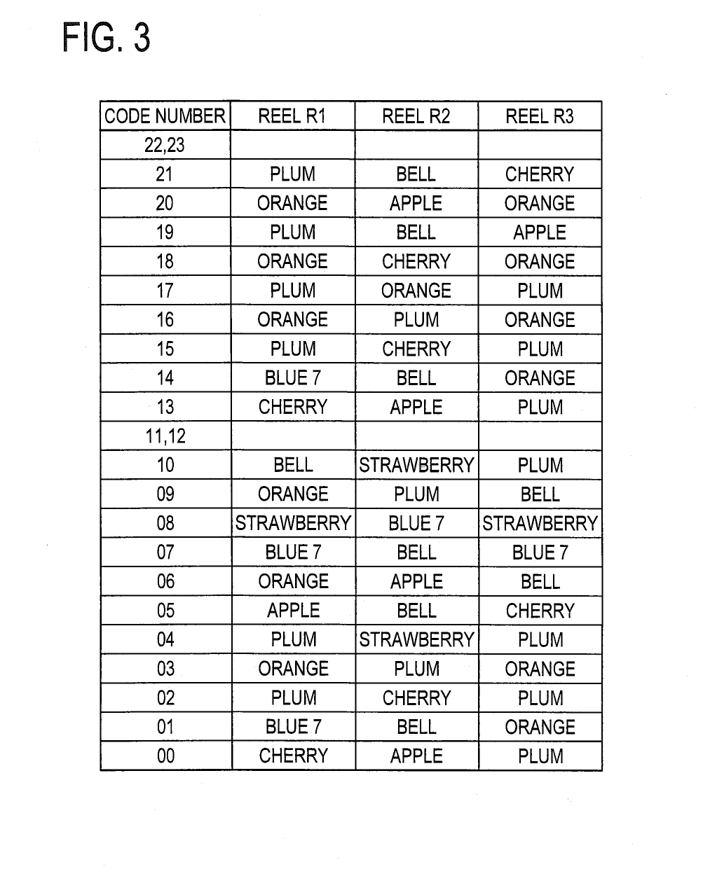

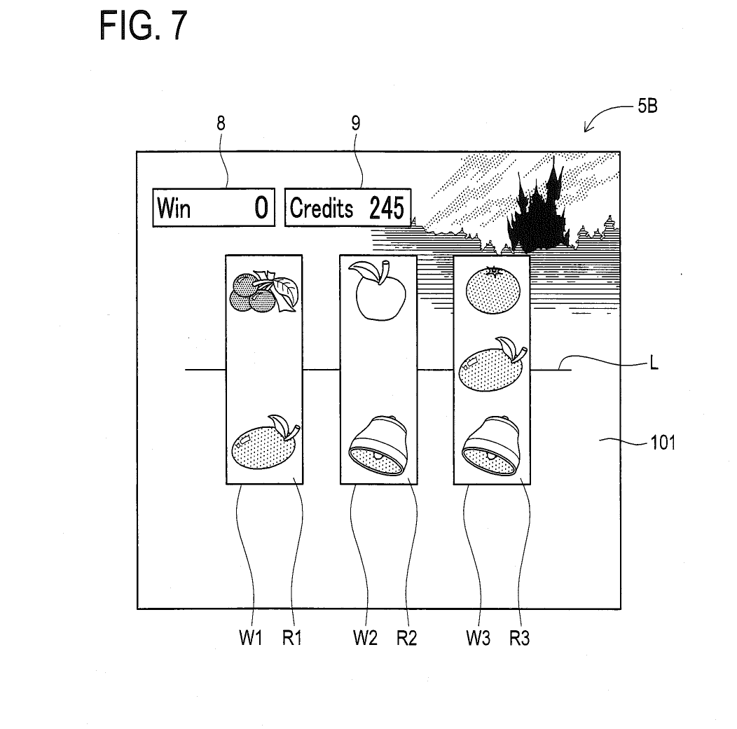

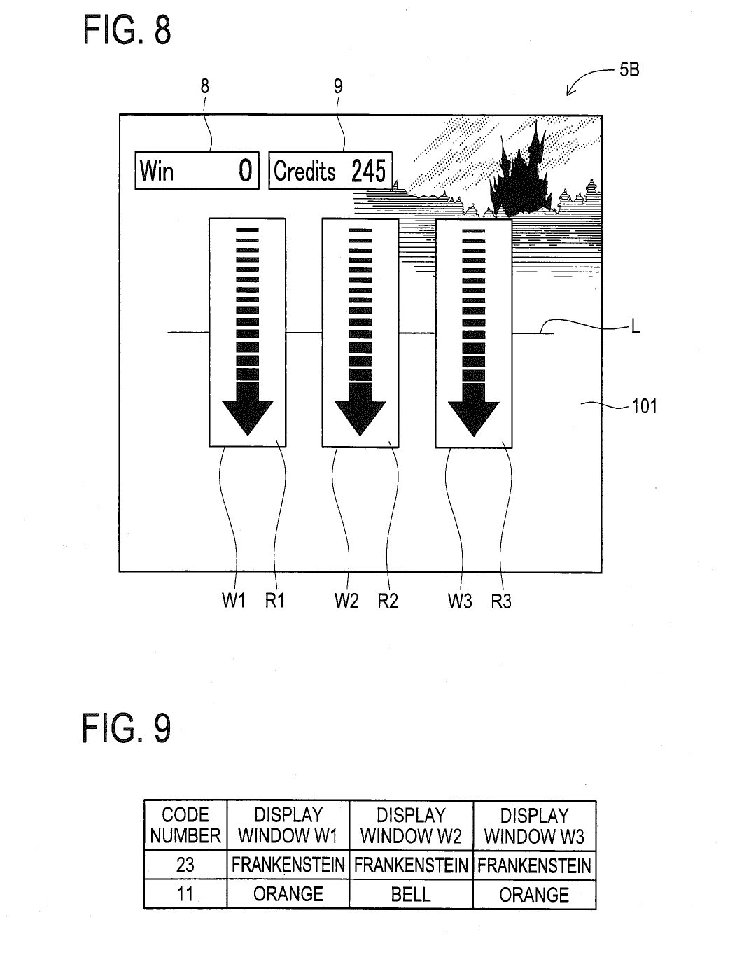

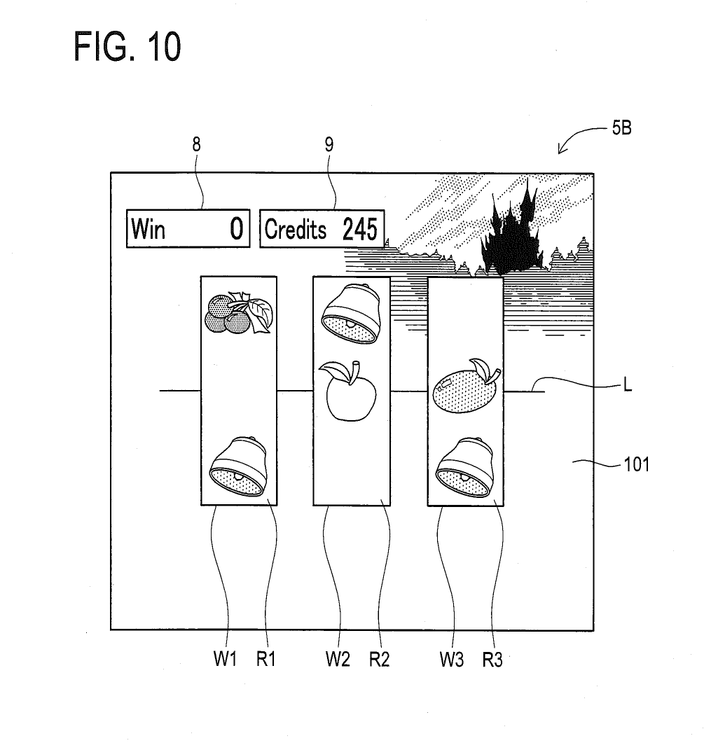

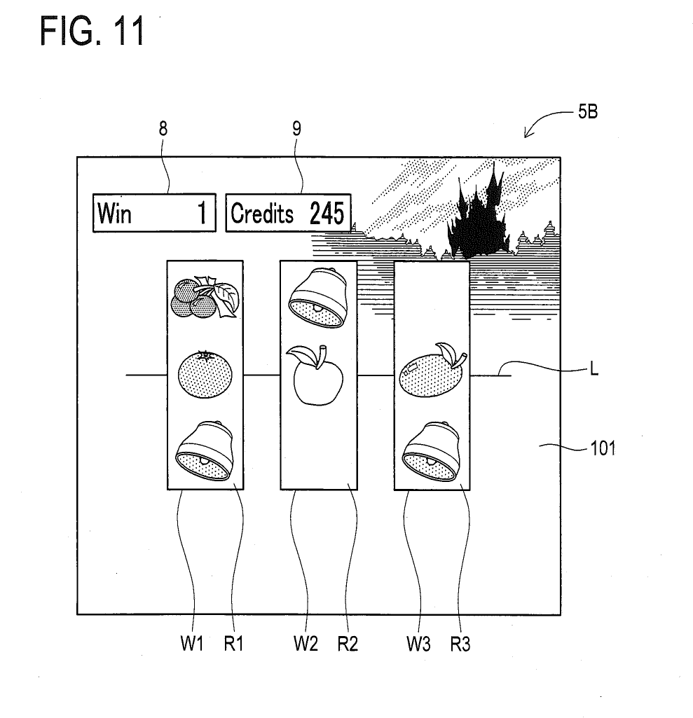

Here, the image of the base game displayed on the liquid crystal panel 5B will be explained. FIG. 7, FIG. 8, FIG. 10 and FIG. 11 are the figures showing the contents displayed on the liquid crystal panel 5B. On the liquid crystal panel 5B, in the base game, as shown in FIG. 7, FIG. 8, FIG. 10 and FIG. 11, each display window W1, W2 and W3 is changed to a transparent state, the symbols drawn on the reel band of each reel R1, R2 and R3 may be visible by the player. FIG. 7, FIG. 10 and FIG. 11 show the arranged or rearranged state of the symbols which are drawn on the reel band of each reel R1, R2 and R3, through each display window W1, W2 and W3 of the liquid crystal panel 5B. FIG. 8 shows the rotating state of the symbols which are drawn on the reel band of each reel R1, R2 and R3, through each display window W1, W2 and W3. On the reel band of each reel R1, R2 and R3, a symbol column constructed from twenty-two symbol, including the blanks, is drawn respectively (refer to FIG. 3).

Also, in front of the liquid crystal panel 5B, the touch panel 101 is arranged, and the player may input his/her various instructions by operating the touch panel 101.

On the liquid crystal panel 5B, the payout amount display portion 8 and the credit amount display portion 9 are arranged. On the payout amount display portion 8, the payout amount obtained in the base game (slot game) by the player is displayed. On the credit amount display portion 9, the credit amount which is owned by the current player is displayed. Also, on the payout amount display portion 8, the payout amount obtained in the free game by the player is displayed.

Therefore, on the liquid crystal panel 5B in the base game, the three display windows W1, W2 and W3 are changed to a transparent state, three symbols which are drawn on the reel band of each reel R1, R2 and R3 are visible through each display window W1, W2 and W3. On the liquid crystal panel 5B in the base game, as shown in FIG. 7, FIG. 8, FIG. 10 and FIG. 11, the pay line L crossing the three display windows W1, W2 and W3 horizontally is displayed. The pay line L is used to specify the symbol combination.

Further, three symbols which have been drawn on the reel band of the reel R1 are rearranged through the display window W1 which is in a transparent state in the liquid crystal panel 5B during the base game. In this case, as shown in FIG. 7 and FIG. 10, if the specified target symbol of the pay line L is a blank, the [FRANKENSTEIN] symbol may be displayed, or, as shown in FIG. 11, the [ORANGE] symbol may be displayed (refer to FIG. 9) on the display window W1 which is in a transparent state, over that blank. In this case, the [FRANKENSTEIN] symbol or the [ORANGE] symbol is handled as specified target of the pay line L, in place of the blank.

In FIG. 11, an [ORANGE] symbol is displayed on the display window W1 in the liquid crystal panel 5B. The symbol combination specified on the pay line L consists of the three symbols [ORANGE], [APPLE] and [PLUM]. If the [FRANKENSTEIN] symbol is displayed on the display window W1 in the liquid crystal panel 5B, the [FRANKENSTEIN] symbol migrates from inside the display window W to outside and under the display window W1, where it is displayed, as shown in the picture at the left side on the first stage in FIG. 1. The same happens in the case of the display window W3 (refer to FIG. 9).

Further, three symbols which are drawn on the reel band of the reel R2 are rearranged through the display window W2 which is in a transparent state. In this case, if the specified target symbol of the pay line L is a blank, the [FRANKENSTEIN] symbol or the [BELL] symbol (refer to FIG. 9) may be displayed on the display window W2 which is in a transparent state, over the blank. In this case, the [FRANKENSTEIN] or [BELL] symbol is handled as the specified target of the pay line L, in place of the blank. If the [FRANKENSTEIN] symbol is displayed on the display window W2 in the liquid crystal panel 5B, the [FRANKENSTEIN] symbol migrates from inside the display window W2 to outside and under the display window W2, where it is displayed as shown in the picture at the right side on the second stage in FIG. 1.

The symbol combination specified on the pay line L is constituted of three [FRANKENSTEIN] symbols. In this case, as shown in the picture at the left side on the first stage and the picture at the right side on the second stage in FIG. 1, the respective [FRANKENSTEIN] symbols migrate from inside the respective display windows W1, W2 and W3 to outside and under the respective display windows W1, W2 and W3, where they are displayed, and the game shifts from the base game to the free game. Immediately after shifting from the base game to the free game, in the liquid crystal panel 5B, the respective display windows W1, W2 and W3 are changed to a non-transparent state, as shown in the picture at the left side on the second stage and the picture at the left side on the third stage in FIG. 1. In this state, the player cannot see the symbols drawn on the reel bands of the respective reels R1, R2 and R3. As shown in the picture at the left side on the second stage, and the pictures at both sides on the third stage in FIG. 1, the liquid crystal panel 5B displays display windows W4 and W5. The display windows W4 and W5 have video reels V1 and V2, respectively, for determining the predetermined number of games for the free game and the predetermined multiple number for the free game.

Returning to FIG. 2, between the middle variable display portion 4B and the lower display portion 4C, at the front of the cabinet 3, an operation table 10 which is projected forward is arranged. On the operation table 10, a variety of operation buttons 11 including a BET button, a collecting button, a spin button, a CASHOUT button, are arranged as the operation portion to execute the game. On the operation table 10, a coin insertion slot 12 and a bill insertion portion 13 are arranged. Also between the operation table 10 and the middle variable display portion 4B, a ticket printer 14 and a card reader 15 are arranged. At the lowest position of the cabinet 3, a coin tray 16 is also arranged.

In the slot machine 1 of the embodiment, the gaming medium may be coin, bill, or electronic value (credit). Here, the gaming medium may be others as well, such as medal, token, electronic money, or ticket.

On the cabinet 3 of the slot machine 1, light emitting portions 20 are arranged around the game area including the upper display portion 4A, the middle variable display portion 4B, the lower display portion 4C and the operation table 10.

The slot machine 1 also includes a topper effect device 28 which is installed on the cabinet 3. The topper effect device 28 is shaped in a rectangular board shaped, and is arranged almost parallel to the liquid crystal panel 5A of the upper display portion 4A. The cabinet 3 is further provided with speakers 23 on its both sides.

Next, the symbols drawn on the reel band of each reel R1, R2 and R3 will be explained with reference to FIG. 3. These symbols are scrolled and rearranged through each display window W1, W2 and W3 on the liquid crystal panel 5B during the base game and the free game. FIG. 3 is a schematic view schematically showing symbol columns drawn on the reel band of each reel R1, R2 and R3.

On the reel band of each reel R1, R2 and R3, twenty-two symbols are arranged respectively. Each symbol column is constructed from the symbols including [BLUE7], [BELL], [APPLE], [CHERRY], [STRAWBERYY], [PLUM] and [ORANGE], including the blank. And the symbols of the predetermined types are arranged in a predetermined sequence. In FIG. 3, nothing is displayed over the blanks.

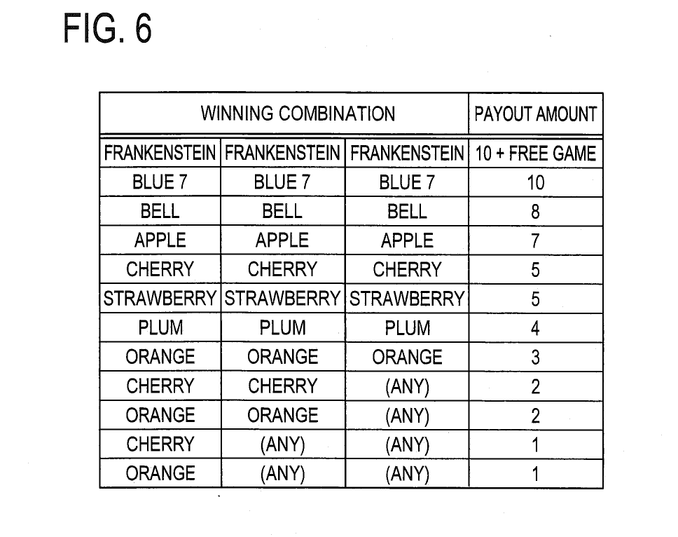

If three of any of the following symbols: [BLUE7], [BELL], [APPLE], [CHERRY], [STRAWBERYY], [PLUM] and [ORANGE] have been rearranged on the pay line L as specified symbols in the liquid crystal panel 5B, a predetermined payout amount is awarded to the player (refer to FIG. 6). If one or two of symbols [CHERRY] or [ORANGE] have been rearranged on the pay line L in the liquid crystal panel 5B as specified symbols, a predetermined payout amount is awarded to the player in accordance with the number of the rearranged symbols (refer to FIG. 6).

In the respective symbol sequences shown in FIG. 3, a symbol number is allocated with respect to each symbol constituting these symbol columns, starting from the top. The symbol numbers at “11” and “12” are each allocated one blank, which they share. Further, the symbol numbers at “22” and “23”, as well, are each allocated one blank, which they share.

Next, symbols displayed as specified targets on the pay line L in the respective display windows W1, W2 and W3 of the liquid crystal panel 5B will be described based on FIG. 9. FIG. 9 shows the correspondence relationships between the symbols, which are displayed as specified targets of the pay line L in the respective display windows W1, W2 and W3 of the liquid crystal panel 5B, and the symbol numbers.

As shown in FIG. 9, the symbols displayed as specified targets of the pay line L in the display window W1 of the liquid crystal panel 5B include symbols [FRANKENSTEIN] and [ORANGE]. A symbol number “23” is allocated to the [FRANKENSTEIN] symbol, and a symbol number “11” is allocated to the [ORANGE] symbol. This is the same for symbols which are displayed as specified targets of the pay line L in display window W3 of the liquid crystal panel 5B.

The symbols displayed as specified targets of the pay line L in the display window W2 of the liquid crystal panel 5B include symbols [FRANKENSTEIN] and [BELL]. A symbol number “23” is allocated to the [FRANKENSTEIN] symbol, and a symbol number “11” is allocated to the [BELL] symbol.

If the [FRANKENSTEIN] symbol is displayed as specified target of the pay line L in the respective display windows W1, W2 and W3 of the liquid crystal panel 5B, a predetermined payout amount is awarded to the player, and the game shifts from the base game to the free game (refer to FIG. 6).

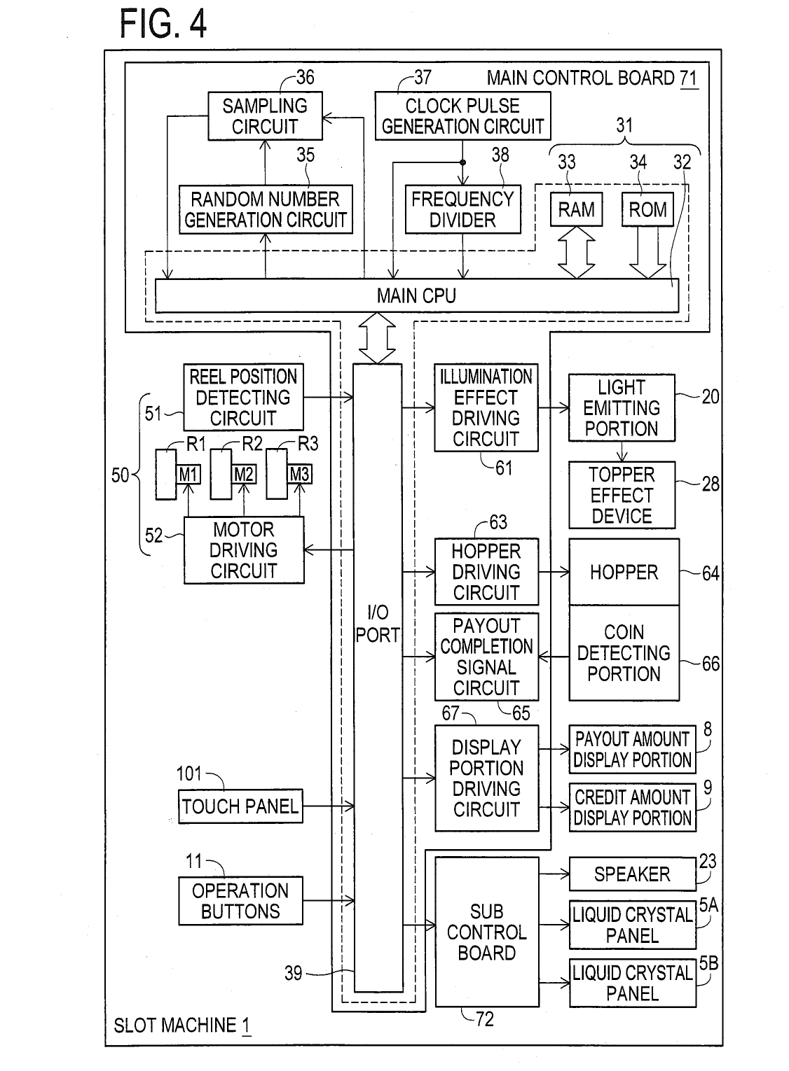

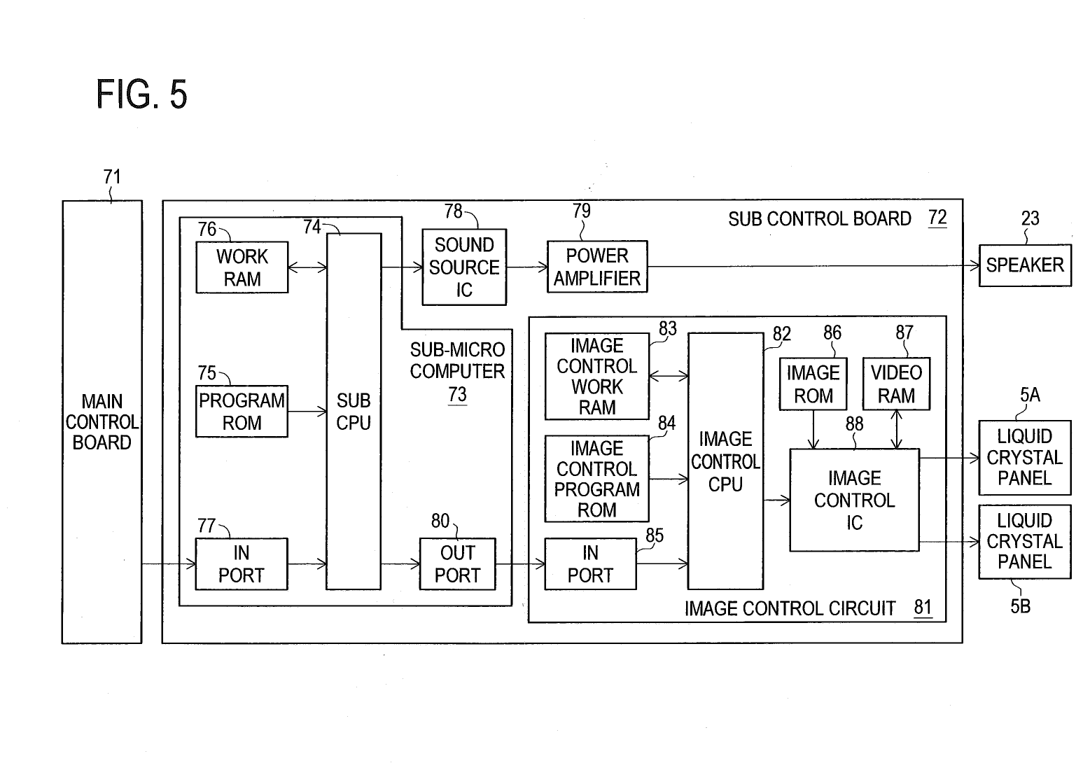

Next, the internal construction of the above slot machine 1 will be explained with reference to FIG. 4 and FIG. 5.

FIG. 4 is a block diagram schematically showing the internal construction of entire slot machine 1. As shown in FIG. 4, the slot machine 1 includes a plurality of construction elements such as the main control board 71, in which a microcomputer 31 is included. The main control board 71 is constructed from the microcomputer 31, a random number generation circuit 35, a sampling circuit 36, a clock pulse generation circuit 37 and a frequency divider 38. The main control board 71 also includes an illumination effect driving circuit 61, a hopper driving circuit 63, a payout completion signal circuit 65 and a display portion driving circuit 67.

The microcomputer 31 is constructed from a main CPU 32, a RAM 33 and a ROM 34. The main CPU 32 runs based on the programs stored in the ROM 34, and inputs/outputs signals with other elements through I/O port 39, so as to execute the control of the entire slot machine 1. Data and programs used when the main CPU 32 runs are stored in the RAM 33. For example, random numbers which are sampled by the after-mentioned sampling circuit 36 are stored temporarily after the start of the game, also the code numbers of the respective reels R1, R2 and R3, the symbol numbers and the code numbers of the respective video reels V1 and V2 are stored in the RAM 33. And the programs executed by the main CPU 32 and the permanent data are stored in the ROM 34.

Especially, the programs stored in the ROM 34 include the game programs and the game system programs (abbreviated as “the game programs and the like” hereinafter). And two lottery programs mentioned below is also included in the game programs.

A first lottery program is a program used to determine the code numbers of the respective reels R1, R2 and R3 which corresponds to each symbol rearranged as specified targets of the pay line L in the liquid crystal panel 5B. In the lottery program, it is included symbol weighing data corresponding to each of plural kinds of payout rates (for example, 80%, 84%, and 88%). The symbol weighing data are the data indicating correlation between the code number of each reel and one or plural random numbers belonging to a predetermined number range (0 to 255), every each of the three reels R1, R2 and R3. In other words, each of the code number of one reel is associated with one or more random numbers corresponding to the payout rate. The random number is extracted by the lottery program, and the symbol specified finally by the random number is rearranged as specified targets of the pay line L in the liquid crystal panel 5B.

A second lottery program also includes a program for determining the code number of the video reel V1 corresponding to the predetermined number of games displayed on the liquid crystal panel 5B and the code number of the video reel V2 corresponding to the predetermined multiple number displayed on the liquid crystal panel 5B. In the lottery program, it is included symbol weighing data corresponding to each of plural kinds of payout rates (for example, 80%, 84%, and 88%). The symbol weighing data are the data indicating correlation between the code number of each reel and one or plural random numbers belonging to a predetermined number range (0 to 255), every each of the two video reels V1 and V2. In other words, each of the code number of one reel is associated with one or more random numbers corresponding to the payout rate. The random number is extracted by the lottery program, and the predetermined number of games or the predetermined multiple number specified finally by the random number is displayed on the liquid crystal panel 5B.

Random numbers over a predetermined range are generated by the random number generation circuit 35, which is operated based on the instructions from the main CPU 32. The random numbers are voluntarily extracted from the random numbers generated by the random number generation circuit 35 by the sampling circuit 36, based on the instructions from the main CPU 32, and the extracted random numbers are input to the main CPU 32. The base clock for running the main CPU 32 is generated by the clock pulse generation circuit 37, and the signals which are generated by dividing the base clock in a predetermined frequency are input to the main CPU 32 by the frequency divider 38.

And to the main control board 71, a reel driving unit 50 is connected. The reel driving unit 50 includes a reel position detection circuit 51 which detects the positions of the three reels R1, R2 and R3, and a motor driving circuit 52 which inputs the driving signals to the motors M1, M2 and M3 which are used to rotate the reels R1, R2 and R3. The motors M1, M2 and M3 are operated based on the driving signals input from the motor driving circuit 52, and rotate the reels R1, R2 and R3, and stop the reels R1, R2 and R3 at a desired position.

Furthermore, the touch panel 101 is connected to the main control board 71. The touch panel 101 is arranged in front of the liquid crystal panel 5B, and specifies the coordinate position of the portion touched by the player. The position on which the player touched and the direction of the movement of the touched portion are determined based on the specified coordinate position information. And the signals corresponding to the determination are input to the main CPU 32 through I/O port 39.

Also, the operation buttons 11 for instructing the execution of the game are connected to the main control board 71. The operation buttons 11 include a spin button, a collecting button and a BET button and the like. The signals corresponding to the pressing of these buttons are input to the main CPU 32 through I/O port 39.

The effect signals which are used to conduct illumination effect are output to the above-mentioned light emitting portion 20 and the topper effect device 28 by the illumination effect driving circuit 61. And the topper effect device 28 is serially connected to the illumination effect driving circuit 61 through light emitting portions 20.

A hopper 64 is driven by the hopper driving circuit 63 based on the control of main CPU 32. The hopper 64 executes the payout of coins, and coins are paid out from the coin tray 16. The data of the number of coins are input from the connected coin detecting portion 66 by the payout completion signal circuit 65. When the number of coins becomes a predetermined number, the signal indicating the completion of the coins is input to the main CPU 32. The number of the coins paid out from the hopper 64 is calculated by the coin detecting portion 66, and the data of the number calculated are input to the payout completion signal circuit 65. The display operation of the payout amount display portion 8 and credit amount display portion 9 is controlled by the display portion driving circuit 67.

Furthermore, a sub control board 72 is connected to the main control board 71. As shown in FIG. 5, commands from the main control board 71 are input to the sub control board 72. The display control on the liquid crystal panel 5A of the upper display portion 4A and the liquid crystal panel 5B of the variable display portion 4B, and the sound output control on the speaker 23 are executed by the sub control board 72. The sub control board 72 is constructed on a circuit board different from the circuit board for the main control board 71, and includes a microcomputer 73 (abbreviated as “sub-microcomputer” hereinafter) as a main construction element, and a sound source IC 78, a power amplifier 79 and an image control circuit 81. The sound source IC 78 controls the sound output from the speaker 23, the power amplifier 79 is used as an amplification device, and the image control circuit 81 is used as the display control device of the liquid crystal panel 5A and 5B.

The sub-microcomputer 73 includes a sub CPU 74, a program ROM 75, a work RAM 76, an IN port 77 and an OUT port 80. The control operations are executed by sub CPU 74 based on the control order transmitted from the main control board 71, the program ROM 75 is used as a memory device. Although a clock pulse generation circuit, a frequency divider, a random number generation circuit and a sampling circuit are not included in the sub control board 72, the sub control board 72 is constructed so as to execute random number sampling according to the operation programs thereof. The control programs executed by the sub CPU 74 are stored in the program ROM 75. The work RAM 76 is constructed as a temporary storing means when the above control programs are executed by the sub CPU 74.

The image control circuit 81 includes an image control CPU 82, an image control work RAM 83, an image control program ROM 84, an IN port 85, an image ROM 86, a video RAM 87 and an image control IC 88. The images displayed on the liquid crystal panel 5A and 5B are determined by the image control CPU 82, based on the parameters set by the sub-microcomputer 73, according to the image control programs stored in the image control program ROM 84.

The image control programs regarding to the display of the liquid crystal panel 5A, 5B and a variety of the selection tables are stored in the image control program ROM 84. The image control work RAM 83 is constructed as a temporary storing means when the image control programs are executed by image control CPU 82. Images corresponding to the content determined by the image control CPU 82 are formed by the image control IC 88, and are output to the liquid crystal panel 5A, 5B.

In the image ROM 86, the dot data used to form images are stored. The video RAM 87 runs as a temporary storing means when the images are formed by the image control IC 88.

Next, winning combinations and the payout amounts corresponding to the winning combinations will be explained with reference to FIG. 6, wherein the winning combinations are the symbol combinations when the base game or the free game is executed in the slot machine 1 according to the embodiment. FIG. 6 is a payout table in which the winning combinations and the payout amounts corresponding to the winning combinations are shown when the base game or the free game is executed.

Here, the payout amount shown in FIG. 6 indicates the payout amount when the bet number is “1” in the base game. Therefore, when the bet number is “1”, the payout amount shown in FIG. 6 is paid out, and when the bet number is more than “2”, the payout amount obtained by multiplying the payout amount shown in FIG. 6 with the bet number is paid out.

On the other hand, the payout amount shown in FIG. 6 indicates the payout amount when the predetermined magnification is “1” in the free game. Therefore, in the free game, the payout amount obtained by multiplying the payout amount shown in FIG. 6 with the predetermined magnification is provided to the player.

Thereby, when three symbols of [FRANKENSTEIN] are displayed as specified targets of the pay line L in the liquid crystal panel 5B, the payout amount obtained by multiplying 10 credits with the bet number or the predetermined magnification is paid out. And in the base game, when the bonus trigger is realized, the free game is generated. Also, in the free game, the bonus trigger may be realized, at that time, a new free game is generated.

When three symbols of [BLUE 7] are rearranged as specified targets of the pay line L in the liquid crystal panel 5B, the payout amount obtained by multiplying 10 credits with the bet number or the predetermined magnification is paid out.

When three symbols of [BELL] are rearranged or displayed as specified targets of the pay line L in the liquid crystal panel 5B, the payout amount obtained by multiplying 8 credits with the bet number or the predetermined magnification is paid out.

The payout amount corresponding to each winning combination shown in FIG. 6, are set as the same in the above. However, when a symbol combination constructed from the symbols rearranged or displayed as specified targets of the pay line L in the liquid crystal panel 5B, is not any of the winning combinations shown in FIG. 6, the symbol combination is not a winning combination. Therefore, no credits may be paid out.

As mentioned above, in the slot machine 1 according to the embodiment, the slot game is executed as the base game, and the free game is executed as the bonus game respectively.

In other words, in the base game, the slot game is executed by rearranging or displaying a specific symbol combination on the pay line L of the liquid crystal panel 5B. In the slot game, firstly, a part of symbol column (three symbols) drawn on the reel band of each reel R1, R2 and R3 (shown in FIG. 3), is arranged on the liquid crystal panel 5B through each transparent display windows W1, W2 and W3 (refer to FIG. 7). Here, after the player sets the bet number by pressing the BET button among the operation buttons 11, if the player presses the spin button, each of the reels R1, R2 and R3 rotates, the symbol column drawn on the reel band of each reel R1, R2 and R3 shown in FIG. 3, is scrolled from up to down and displayed on the liquid crystal panel 5B, through each of the transparent display windows W1, W2 and W3 (refer to FIG. 8).

After a predetermined time, each reel R1, R2 and R3 stops automatically, a part of the symbol column (three symbols) drawn on the reel band of each reel R1, R2 and R3 (shown in FIG. 3), is rearranged on the liquid crystal panel 5B through each transparent display window W1, W2 and W3 (refer to FIG. 7 and FIG. 10). If a blank is rearranged as a symbol which is handled as a specified target of the pay line L in the liquid crystal panel 5B, another symbol may be displayed on the liquid crystal panel 5B, over that blank (refer to FIG. 1 and FIG. 11). On the other hand, each winning combination based on each symbol combination is determined beforehand (refer to FIG. 6). When the symbol combination constructed from the three symbols rearranged or displayed as specified targets of the pay line L in the liquid crystal panel 5B, realizes a winning combination, the payout amount obtained by multiplying the bet number with the payout amount corresponding to the realized winning combination is provided to the player.

On the other hand, in the free game as the bonus game, the slot game, in which a specific symbol combination is rearranged or displayed as specified targets of the pay line L in the liquid crystal panel 5B, is repeated over a predetermined number of times. Also, in the slot game, a part of the symbol column (three symbols) drawn on the reel band of each reel R1, R2 and R3 as shown in FIG. 3, is arranged on the liquid crystal panel 5B through each transparent display window W1, W2 and W3 (refer to FIG. 7). However, here, after a predetermined time, each reel R1, R2 and R3 rotates automatically. Thereby, no matter whether the player presses the operation buttons 11 such as the BET button or the spin button, the symbol column drawn on the reel band of each reel R1, R2 and R3 as shown in FIG. 3, is scrolled from up to down and displayed on the liquid crystal panel 5B, through each transparent display window W1, W2 and W3 (refer to FIG. 8).

Furthermore, after a predetermined time, each reel R1, R2 and R3 stops automatically, a part of the symbol column (three symbols) drawn on the reel band of each reel R1, R2 and R3 as shown in FIG. 3, is rearranged on the liquid crystal panel 5B through each transparent display window W1, W2 and W3 (refer to FIG. 7 and FIG. 10). If a blank is rearranged as a symbol which is handled as a specified target of the pay line L in the liquid crystal panel 5B, another symbol may be displayed on the liquid crystal panel 5B, over that blank (refer to FIG. 1 and FIG. 11). On the other hand, similar to the above base game, each kind of winning combination is determined beforehand based on the symbol combination (refer to FIG. 6). When the symbol combination, which is constructed from the three symbols rearranged or displayed as specified targets of the pay line L in the liquid crystal panel 5B, is a winning combination, the payout amount obtained by multiplying the payout amount corresponding to the realized winning combination with the predetermined magnification is provided to the player.

The predetermined number of games for the free game and the predetermined multiple number for the free game are determined after the game shifts to the free game, and display thereof using video reels V1 and V2 which are displayed in a scrolled manner and stopped manner on the display windows W4 and W5 of the liquid crystal panel 5B is same as described above.

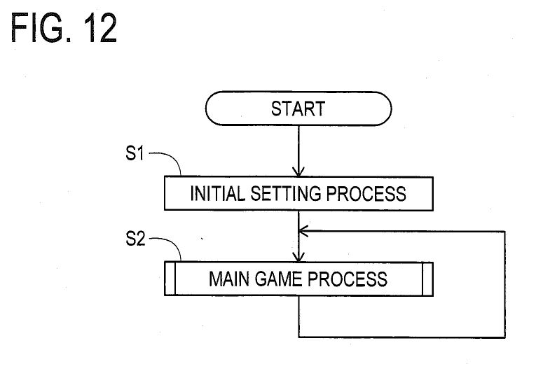

Next, a main control program executed in the slot machine 1 according to the embodiment will be explained with reference to figures. FIG. 12 is a flowchart of the main control program.

First, when the power switch is pressed, the microcomputer 31 is started to operate, an initialization is executed by the microcomputer 31 in step (abbreviated as “S”) 1. In an initial setting process, the BIOS stored in the ROM 34 is executed by the main CPU 32. The compressed data included in the BIOS is expanded to the RAM 33, and when the BIOS expansion to the RAM 33 is executed, the diagnosing and initialization process of the various peripheral devices are executed. Also, the game programs and the like are written from the ROM 34 to the RAM 33 by the main CPU 32, so as to obtain the payout rate setting data and the country ID information. Also, during the execution of the initial setting process, the verification process to each program is executed.

And in S2, the main CPU 32 reads out the game programs and the like from the RAM 33, and executes the programs in sequence so as to conduct a main game process. The game is executed in the slot machine 1 according to the embodiment by executing the main game process. And the main game process is repeated when the power is supplied to the slot machine 1.

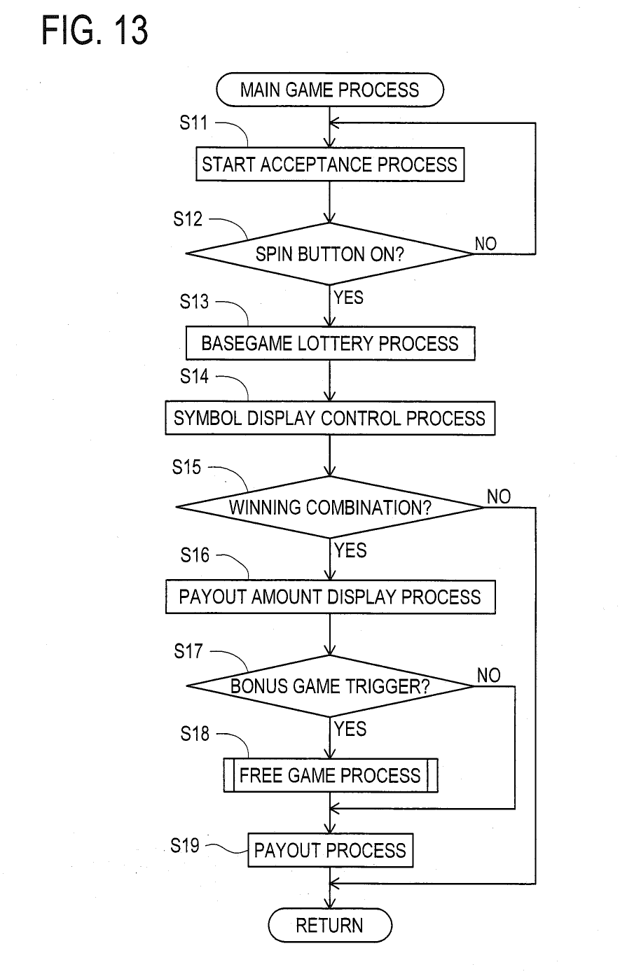

Next, sub process of the main game process in S2 will be explained with reference to FIG. 13. FIG. 13 is a flowchart of the main game process program in the slot machine 1 according to the embodiment. Also, each program shown in the flowchart of FIG. 13 is stored in the ROM 34 or the RAM 33 of the slot machine 1, and is executed by the main CPU 32.

First, as shown in FIG. 13, a start acceptance process is executed by the main CPU 32 in S11. At this time, in the start acceptance process, the insertion of the coins or the bet operation using the BET button among the operation buttons 11 is executed by the player. And the control signals are transmitted to the sub control board 72 by the main CPU 32, so that each display window W1, W2 and W3 of the liquid crystal panel 5B is shift/maintained in a transparent state.

And then, it is determined by the main CPU 32 whether the spin button among the operation buttons 11 is pressed in S12. It is determined based on the input signals corresponding to the button pressing of the operation button 11 to the main CPU 32. Here, when the spin button among the operation buttons 11 is not pressed (S12: NO), the game returns to the start acceptance process (S11) again. Thereby, it is possible to change the bet number and the like. On the other hand, when the spin button among the operation buttons 11 is pressed (S12: YES), the bet number set based on the above bet operation is reduced from the credits owned by the player at that time, and is stored in the RAM 33 as the bet information. And the credit count after reduction is also stored in the RAM 33 as the bet information.

In S13, a base game lottery process is executed by the main CPU 32. Concretely, when the first lottery program included in the game programs is executed by the main CPU 32, the random number corresponding to each reel R1, R2 and R3 respectively is selected from a range of 0 to 255. And with reference to the symbol weighing data corresponding to the payout rate setting data, based on the three random numbers, the code numbers of the respective reels R1, R2 and R3 is determined. The determined code numbers of the respective reels R1, R2 and R3 is stored in the RAM 33 by the main CPU 32, and the game proceeds to S14.

Here, the code numbers of the respective reels R1, R2 and R3 are associated with the symbol numbers (symbol numbers shown in FIG. 3 and FIG. 9) of the symbols which are rearranged or displayed as specified targets of the pay line L in the liquid crystal panel 5B. The main CPU 32 determines the symbol combination of that game by determining the code numbers of the respective reels R1, R2 and R3. For instance, if the code numbers of the respective reels R1, R2 and R3 are set to “22”, “22” and “22”, the main CPU 32 decides for a symbol combination made up of three blanks (refer to FIG. 3). If the code numbers of the respective reels R1, R2 and R3 are set to “23”, “23” and “23”, the main CPU 32 decides for a symbol combination made up of three [FRANKENSTEIN] symbols (refer to FIG. 3 and FIG. 9). Further, if the code numbers of the respective reels R1, R2 and R3 are set to “12”, “12” and “12”, the main CPU 32 decides for a symbol combination made up of three blanks (refer to FIG. 3). Further, if the code numbers of the respective reels R1, R2 and R3 are set to “11”, “11” and “11”, the main CPU 32 decides for a symbol combination made up of symbols [ORANGE], [BELL] and [ORANGE] (refer to FIG. 3 and FIG. 9). Lottery for the symbol combination in the base game is carried out by determining the code numbers of the respective reels R1, R2 and R3.

When the game proceeds to S14, a symbol display control process is executed by the main CPU 32. Concretely, first, a reel rotation process is executed by the main CPU 32. In other words, each motor M1, M2 and M3 is driven by the main CPU 32 through the motor driving circuit 52, so as to rotate each reel R1, R2 and R3. And then, the effect mode (the display mode of the images on the liquid crystal panel 5B and the sound output mode from the speaker 23) for each unit game is determined by the main CPU 32, and the sub control board 72 is ordered to start the effect in a predetermined effect pattern. And then, when the predetermined stop timing to stop each reel R1, R2 and R3 comes, a reel stop process is executed by the main CPU 32 through the motor driving circuit 52, thereby each reel R1, R2 and R3 is stopped based on the code numbers stored in the RAM 33.

If the code numbers stored in the RAM 33 are “11” or “23”, in S14, the main CPU 32 rearranges the blanks as symbols which are handled as specified targets of the pay line L in the liquid crystal panel 5B, as was described earlier. At the same time, the main CPU 32 displays any of the symbols [FRANKENSTEIN], [ORANGE] and [BELL] on the liquid crystal panel 5B as specified target of the pay line L, over the blank, by transmitting a control signal to the sub control board 72.

More specifically, in case the code number of the reel R1 is “11”, the blank is rearranged as a symbol which is handled as a specified target of the pay line L through the display window W1 of the liquid crystal panel 5B, by causing the reel R1 to rotate and then stop. Then, the [ORANGE] symbol is displayed on the display window W1 of the liquid crystal panel 5B as a symbol handled as a specified target of the pay line L. In case the code number of the reel R1 is “23”, the blank is rearranged as a symbol which is handled as a specified target of the pay line L through the display window W1 of the liquid crystal panel 5B, by causing the reel R1 to rotate and then stop. Then, the [FRANKENSTEIN] symbol is displayed on the display window W1 of the liquid crystal panel 5B as a symbol handled as a specified target of the pay line L. Further, the [FRANKENSTEIN] symbol which was displayed on the display window W1 of the liquid crystal panel 5B is caused to migrate from inside the display window W1 of the liquid crystal panel 5B to outside and under the display window W1, where it is displayed.

The same operation happens with respect to the display window W3 of the liquid crystal panel 5B, in the case that the code number of the reel R3 is “ii” or “23”.

In case the code number of the reel R2 is “11”, the blank is rearranged as a symbol which is handled as a specified target of the pay line L through the display window W2 of the liquid crystal panel 5B, by causing the reel R2 to rotate and then stop. Then, the [BELL] symbol is displayed on the display window W2 of the liquid crystal panel 5B as a symbol handled as a specified target of the pay line L. In case the code number of the reel R2 is “23”, the blank is rearranged as a symbol which is handled as a specified target of the pay line L through the display window W2 of the liquid crystal panel 5B, by causing the reel R2 to rotate and then stop. Then, the [FRANKENSTEIN] symbol is displayed on the display window W2 of the liquid crystal panel 5B as a symbol handled as a specified target of the pay line L. Further, the [FRANKENSTEIN] symbol which was displayed on the display window W2 of the liquid crystal panel 5B is caused to migrate from inside the display window W2 of the liquid crystal panel 5B to outside and under the display window W2, where it is displayed.

Then, the main CPU 32 proceeds to S15, at which it determines whether or not a winning combination has been realized. This determination is made based on the code numbers of the respective reels R1, R2 and R3 that were stored in the RAM 33. If a winning combination has not been realized (S15: NO), in case a symbol is displayed on the liquid crystal panel 5B, the main CPU 32 erases the symbol from the liquid crystal panel 5B by transmitting a control signal to the sub control board 72, and then executes this program once again. Alternatively, if the winning combination has been realized (S15: YES), the flow proceeds to S16.

In S16, the main CPU 32 executes a payout amount display process. More specifically, first, the main CPU 32 calculates an amount obtained by multiplying the payout amount in accordance with the winning combination handled as specified target of the pay line L in the liquid crystal pane 5B, by the bet amount. This calculation is made based on the bet information stored in the RAM 33 and the payout table in FIG. 6, in addition to the code numbers of the respective reels R1, R2 and R3, and the calculated amount is stored in the RAM 33 as payout information. Then, the main CPU 32 displays the payout information (calculated amount) stored in the RAM 33 on the payout amount display portion 8 of the liquid crystal panel 5B, by transmitting a control signal to the display portion driving circuit 67.

Then, the main CPU 32 proceeds to S17, at which it judges whether or not the bonus game trigger is realized. More specifically, if three [FRANKENSTEIN] symbols are displayed as symbols which are handled as specified targets of the pay line L in the liquid crystal panel 5B, it is determined that the bonus game trigger is realized (refer to the picture at the right side on the second stage in FIG. 1). This determination as well is carried out based on the code numbers of the respective reels R1, R2 and R3 stored in the RAM 33. If the bonus game trigger is realized (S17: YES), the main CPU 32 causes the display windows W1, W2 and W3 of the liquid crystal panel 5B to enter a non-transparent state, by transmitting a control signal to the sub control board 72. At the same time, the main CPU 32 erases the symbols displayed on the liquid crystal panel 5B (refer to the picture at the left side on the second stage in FIG. 1). Further, the main CPU 32 executes a free game process in S18. The free game process will be described in detail later.

Next, in S19, a payout process is executed, including the case when the bonus game trigger is not realized (S17: NO). In the payout process, the payout amount obtained by the player in the base game and the free game, is paid out to the player respectively, based on the payout information stored in the RAM 33.

When the payout is executed, the credits which are stored in the RAM 33 as the payout information (the payout amount obtained by the player in the base game and the free game respectively) are added to the credits stored in the RAM 33 as the credit information, and the added value is overwritten in the RAM 33 as the credit information. And then, the control signals are transmitted to the display portion driving circuit 67 by the main CPU 32, the credits information stored in the RAM 33 (the added value in S19) is displayed on the credit display portion 9 of the liquid crystal panel 5B. At the same time, “0” is overwritten to the RAM 33 as the payout information, and by transmitting the control signals to the display portion driving circuit 67, on the payout amount display portion 8 of the liquid crystal panel 5B, “0” is displayed.

In this payout process, when the player depresses the CASHOUT button from the operation buttons 11, the credit amount that the player currently possesses can be paid out in coins, corresponding to that amount (1 credit corresponding to 1 coin). Alternatively, the credit amount can be paid out through barcode-attached tickets which are printed in the ticket printer 14.

Then, after the payout process in S19, if symbols and display windows W4 and W5 are displayed on the liquid crystal panel 5B, the main CPU 32 erases the symbols and the display windows W4 and W5 from the liquid crystal panel 5B by transmitting a control signal to the sub control board 72. Then, the main CPU 32 executes the main game process once again.

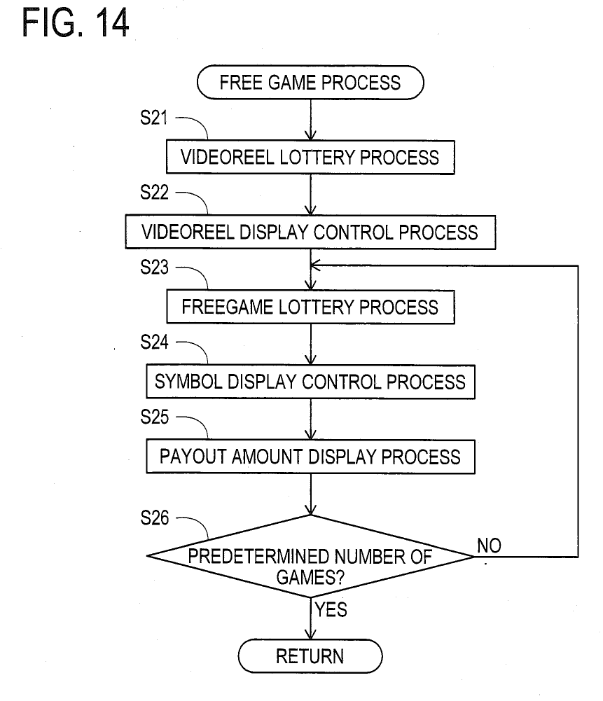

Next, the sub process of the free game process in above S18 will be explained with reference to FIG. 14. FIG. 14 is a flowchart of a sub process program of the free game in the slot machine 1 according to the embodiment. The program shown in the flowchart of FIG. 14 is stored in the ROM 34 or the RAM 33 of the slot machine 1, and is executed by the main CPU 32.

In the free game process in S18, the main CPU 32 first executes a video reel lottery process in S21. More specifically, the main CPU 32 selects random numbers respectively corresponding to each video reel V1 and V2, from numerical number range [0 through 255], by executing a second lottery program included in the game program. The main CPU 32 determines the code numbers of the respective video reels V1 and V2 based on the two selected random numbers, by referencing the symbol weighing data in accordance with the payout rate setting data. After storing the determined code numbers of the respective video reels V1 and V2 in the RAM 33, the main CPU 32 proceeds to S22.

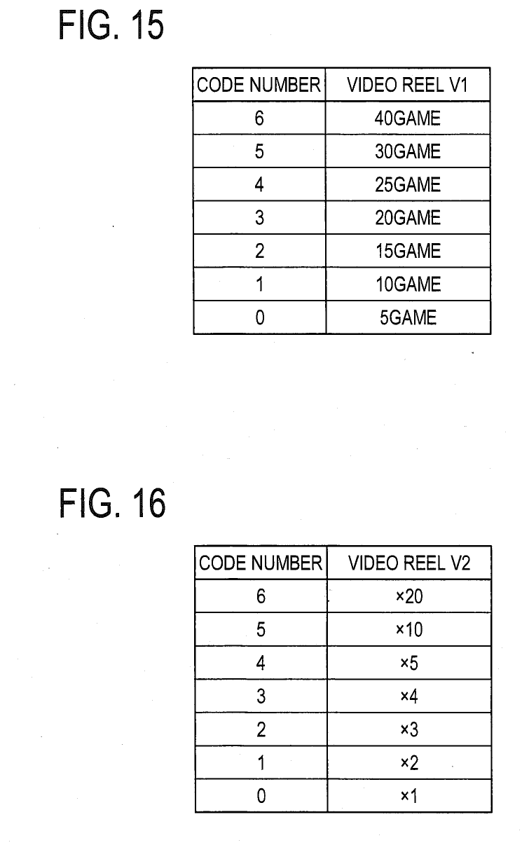

Here, the code numbers of the respective video reels V1 and V2 will be explained. FIG. 15 is a view showing the correspondence relationships between the code numbers of the video reel V1 and the predetermined number of games for the free game. The predetermined number of games for the free game includes [5GAME], [10GAME], [15GAME], [20GAME], [25GAME], [30GAME], [35GAME] and [40GAME]. These form the reel band of the video reel V1. Code numbers are allocated in order to the respective predetermined number of games. FIG. 16 is a view showing the correspondence relationships between the code numbers of the video reel V2 and the predetermined multiple numbers for the free game. The predetermined multiple numbers for the free game include [×1], [×2], [×3], [×4], [×5], [×10] and [×20]. These form the reel band of the video reel V2. Code numbers are allocated in order to the respective predetermined multiple numbers.

Specifically, the code numbers of the video reel V1 are associated with the predetermined number of games in the video reel V1 which is displayed in a stopped state on the display window W4 of the liquid crystal panel 5B. The main CPU 32 thus determines the number of unit games which are carried out repeatedly in the free game by determining the code number of the video reel V1. For instance, if the code number of the video reel V1 is set to “1”, the main CPU 32 decides that the unit game is to be repeated 10 times in the free game (refer to FIG. 15). The main CPU 32 stores the predetermined number of games thus determined in the RAM 33, as predetermined number of games information.

The code numbers of the video reel V2 are associated with the predetermined multiple numbers in the video reel V2 which is displayed in a stopped state on the display window W5 of the liquid crystal panel 5B. The main CPU 32 determines the multiple number, by which number the payout amount acquired in each unit game of the free game is increased through multiplication, by determining the code number of the video reel V2. For instance, if the code number of the video reel V2 is set to “3”, the main CPU 32 decides to increase the payout amount obtained in the respective unit games in the free game by 4 times (refer to FIG. 16). The main CPU 32 stores the predetermined multiple number thus determined in the RAM 33 as predetermined multiple number information.

Returning to FIG. 14, in S22, the main CPU 32 executes a video reel display control process. More specifically, the main CPU 32 transmits a control signal to the sub control board 72. The main CPU 32 then causes the display windows W4 and W5 to be displayed on the liquid crystal panel 5B. The main CPU 32 also causes the rotating video reel V1 to be displayed on the display window W4, and at the same time, causes the rotating video reel V2 to be displayed on the display window W5 (refer to the picture at the left side on the second stage in FIG. 1). When a predetermined stop timing is reached for stopping the rotating video reels V1 and V2, the main CPU 32 transmits a control signal to the sub control board 72, causing the video reels V1 and V2 to be displayed in a stopped manner based on the predetermined number of games information and the predetermined multiple number information stored in the RAM 33 in S21 (refer to the picture at the left side on the third stage in FIG. 1).

Further, in S22, the main CPU 32 transmits the control signal to the sub control board 72, causing the respective display windows W1, W2 and W3 of the liquid crystal panel 5B to become transparent. The player can thus see the respective reels R1, R2 and R3.

In S23, a free game lottery process is executed by the main CPU 32. Concretely, the first lottery program included in the game programs is executed, a random number corresponding to each reel R1, R2 and R3 is selected respectively from the range of 0 to 255. And with reference to the symbol weighing data corresponding to the payout rate setting data, based on the three selected random numbers, the code numbers of the respective reels R1, R2 and R3 is determined. And the determined code number of the respective reels R1, R2 and R3 is stored in the RAM 33, and the game proceeds to S24.

Here, the code numbers of the respective reels R1, R2 and R3 are associated with the symbol numbers (refer to the symbol numbers in FIG. 3 and FIG. 9) for the symbols which are rearranged or displayed as specified targets of the pay line L in the liquid crystal panel 5B. The main CPU 32 thus determines the symbol combination in this game by determining the code numbers of the respective reels R1, R2 and R3. For instance, if the code numbers of the respective reels R1, R2 and R3 are set to “14”, “08” and “07”, the main CPU 32 decides for a symbol combination made up of 3 [BLUE7] symbols (refer to FIG. 3). If the code numbers of the respective reels R1, R2 and R3 are set to “23”, “23” and “23”, the main CPU 32 decides for a symbol combination made up of three [FRANKENSTEIN] symbols (refer to FIG. 3 and FIG. 9). Thus, a lottery for the symbol combination with respect to the free game is carried out by deciding the code numbers of the respective reels R1, R2 and R3. When the game proceeds to S24, a symbol display control process is executed by the main CPU 32. Concretely, first, a reel rotation process is executed by the main CPU 32. In other words, each motor M1, M2 and M3 is driven by the main CPU 32 through the motor driving circuit 52, so as to rotate each reel R1, R2 and R3. And then, the effect mode (the display mode of the images on the liquid crystal panel 5B and the sound output mode from the speaker 23) for each unit game is determined by the main CPU 32, and the sub control board 72 is ordered to start the effect in a predetermined effect pattern. And then, when the predetermined stop timing to stop each reel R1, R2 and R3 comes, a reel stop process is executed by the main CPU 32, through the motor driving circuit 52, each reel R1, R2 and R3 is stopped based on the code numbers stored in the RAM 33.

Further, in S24, if the code number stored in the RAM 33 is “11” or “23”, the main CPU 32 rearranges the blanks as specified targets of the pay line L on the liquid crystal panel 5B. At the same time, the main CPU 32 displays any of the symbols [FANKENSTEIN], [ORANGE] or [BELL] on the liquid crystal panel 5B as specified targets of the pay line L, over the blanks, by transmitting a control signal to the sub control board 72. The same happens in the symbol display control process in the base game.

In S25, a payout amount display process is executed by the main CPU 32. Concretely, first, the payout amount obtained by multiplying the payout amount corresponding to the winning combination specified targets of the pay line L in the liquid crystal panel 5B with the predetermined magnification (the number in the video reel V2 which is displayed in a stopped state on the display window W5 of the liquid crystal panel 5B) is calculated. And the calculation is executed based on the predetermined magnification information stored in the RAM 33 and the payout table of FIG. 6, in addition to the code numbers of the respective reels R1, R2 and R3, and the calculated amount is stored in RAM 33 as the payout information. And then, the control signals are transmitted to the display portion driving circuit 67 by the main CPU 32, the payout information stored in the RAM 33 (the above calculated amount) is displayed on the payout amount display portion 8 of the liquid crystal panel 5B.

The main CPU 32 then proceeds to S26, at which it determines whether the unit game has been repeatedly carried out by the predetermined number of games. For instance, the variable number set in advance in the RAM 33 is [0] when shifting to the free game. Alternatively, this variable number is incremented with each execution of the process in S26. Then, to carry out this determination, this variable number is compared with a predetermined number. The predetermined number of games (number on the video reel V1 which is displayed in a stopped state on the display window W4 of the liquid crystal panel 5B) is a number corresponding to the predetermined number of games information stored in the RAM 33. Here, if the unit game is not repeatedly carried out by the predetermined number of games (S26: NO), the main CPU 32 erases the symbols from the liquid crystal panel 5B, if any are displayed thereon, by transmitting a control signal to the sub control board 72. Then, the main CPU 32 returns to the free game lottery process (S23). As a result, the next unit game is executed. Alternatively, if a predetermined number of unit games are repeatedly executed (S26: YES), this free game process ends, and the flow returns to the main game process in FIG. 13.

As was described in the above text, in the base game (slot game) executed in the slot machine 1 according to the present embodiment, if the symbols handled as specified targets of the pay line L, from amongst the symbols which have been rearranged through the respective display windows W1, W2 and W3 which are in a transparent state in the liquid crystal panel 5B, are blanks, a [FRANKENSTEIN] symbol which is not drawn on the reel bands of the reels R1, R2 and R3 may be displayed on the respective display windows W1, W2 and W3 which are in a transparent state, over the blanks. Further, once the [FRANKENSTEIN] symbols are displayed, the symbols migrate from inside the respective display windows W1, W2 and W3 of the liquid crystal panel 5B to outside and under the respective display windows W1, W2 and W3, where they are displayed. In this case, the symbols handled as specified targets of the pay line L become the [FRANKENSTEIN] symbols, in place of the blanks. If three [FRANKENSTEIN] symbols migrate to outside and under the display windows W1, W2 and W3 of the liquid crystal panel 5B, where they are displayed, the symbol combination specified by the pay line L is made up of three [FRANKENSTEIN] symbols, and is handled as a bonus game trigger (refer to the picture at the right side on the second stage in FIG. 1).

Accordingly, a symbol combination (made up of three [FRANKENSTEIN] symbols) which cannot be achieved in the respective reels R1, R2 and R3, which are mechanical reels, can be handled as a bonus game trigger, and the process of whether or not a bonus game trigger is realized is shown to the player through the liquid crystal panel. Also, the symbol combination (made up of three [FRANKENSTEIN] symbols) which cannot be achieved in the reels R1, R2 and R3, which are mechanical reels, can be handled as a winning combination. Further, the [FRANKENSTEIN] symbols which are trigger symbols have the effect of popping up from the respective reels R1, R2 and R3 which are mechanical reels, showing the bonus game trigger to the player.

When the bonus game trigger is shown to the player as described, the [FRANKENSTEIN] symbols which have been respectively displayed outside and under the respective display windows W1, W2 and W3 in the liquid crystal panel 5B are erased, and at the same time, the predetermined number of games and the predetermined multiple number for the free game are determined.

Two display windows W4 and W5 are displayed outside and under the respective display windows W1, W2 and W3 of the liquid crystal panel 5B. The display window W4 displays the rotating video reel V1 for displaying the predetermined number of games for the free game (refer to the picture at the left side on the second stage in FIG. 1). The display window W5 displays the rotating video reel V2 for displaying the predetermined multiple number for the free game (refer to the picture at the left side on the second stage in FIG. 1). Then, the display window W4 in the liquid crystal panel 5B displays the video reel V1 in a stopped state, thus displaying the predetermined number of games for the free game (refer to the picture at the left side on the third stage in FIG. 1). The display window W5 in the liquid crystal panel 5B displays the video reel V2 in a stopped state thus displaying the predetermined multiple number for the free game (refer to the picture at the left side on the third stage in FIG. 1). The process of displaying the predetermined number of games and the predetermined multiple number for the free game can thus be shown to the player.

In the base game (slot game) and free game executed in the slot machine 1 according to the present embodiment, the symbols which are handled as specified targets of the pay line L, from amongst the symbols which have been rearranged through the respective display windows W1 and W3 which are in a transparent state in the liquid crystal panel 5B, are blanks. In this case, the [ORANGE] symbol which is drawn on the reel bands of the reels R1 and R3 may be respectively displayed on the display windows W1 and W3 which are in a transparent state, over these blanks. If the symbols which are handled as specified targets of the pay line L, from amongst the symbols which have been rearranged through the display window W2 which is in a transparent state in the liquid crystal panel 5B, are blanks, the [BELL] symbol which is also drawn on the reel band of the reel R2 may be displayed on the display window W2 which is in a transparent state, over the blank. In this case, the symbol which is handled as specified target of the pay line L is symbol [ORANGE] or [BELL], in place of the blank. Thus, symbol [ORANGE] or [BELL] which are also drawn on the reels bands of the reels R1, R2 and R3 can constitute a symbol combination specified on the pay line L, in addition to the symbols drawn on the reel bands of reels R1, R2 and R3, even if these symbols are respectively displayed on the display windows W1, W2 and W3 of the liquid crystal panel 5B.

The present invention is not limited to the embodiments described above, and various modifications can be made thereto without departing from the spirit of the invention.

For instance, when the [FRANKENSTEIN] symbols migrate from inside the respective display windows W1, W2 and W3 of the liquid crystal panel 5B to outside and under the respective display windows W1, W2 and W3, where they are displayed, these symbols may be continuously displayed inside the respective display windows W1, W2 and W3 in the liquid crystal panel 5B.

The timing at which the [FRANKENSTEIN] symbols migrate from inside the display windows W1, W2 and W3 of the liquid crystal panel 5B to outside and under the respective display windows W1, W2 and W3, where they are displayed may differ for each display window W1, W2 and W3, in the order of completion of symbol rearranging. After all symbols have been rearranged, the timing for [FRANKENSTEIN] symbol migration and display may be the same for all display windows W1, W2 and W3.

What is claimed is:

1. A slot machine comprising:
mechanical reels wherein symbols and blanks are provided;
a transparent-type liquid crystal display including transparent areas inside which the symbols or blanks of the mechanical reels are in a transparent state, said display being adapted to display a pay line across inside said transparent areas or across outside said transparent areas; and
a processor which is programmed to control the mechanical reels and the transparent-type liquid crystal display and execute processes (a) through (e) as follows:
(a) rotating and stopping the mechanical reels;
(b) if blanks of the mechanical reels have been arranged on the pay line when the mechanical reels are in a stopped state, displaying symbols inside said transparent areas of the transparent-type liquid crystal display so as to overlap the blanks;
(c) if a predetermined number of trigger symbols, from the symbols which have been displayed inside said transparent areas of the transparent-type liquid crystal display, are arranged on the pay line, displaying 2 video reels outside said transparent areas of the transparent-type liquid crystal display for identifying a rotation number of times and a payout magnification rate;
(d) displaying the video reels in a rotating manner and in a stopped manner; and
(e) conducting a free game using the mechanical reels, based on said rotation number of times and payout magnification rate that were identified by displaying the video reels in a stopped state.

2. The slot machine according to claim 1, wherein, in performing the control at the (b), the processor awards a payout to a player based on a symbol combination that was arranged on the pay line, the symbol combination consisting of symbols which are displayed inside said transparent areas of the transparent-type liquid crystal display and symbols of the mechanical reels.

3. The slot machine according to claim 1, wherein, in executing the control at the (c), the processor causes the trigger symbols to migrate from inside said transparent areas of the transparent-type liquid crystal display to outside said transparent areas, where they are displayed.

4. A slot machine comprising:
mechanical reels wherein symbols and blanks are provided;
a transparent-type liquid crystal display including transparent areas inside which the symbols or blanks of the mechanical reels are in a transparent state, said display being adapted to display a pay line across inside said transparent areas or across outside said transparent areas; and
a processor which is programmed to control the mechanical reels and the transparent-type liquid crystal display and execute processes (a) through (e) as follows:
(a) rotating and stopping the mechanical reels;
(b-1) if blanks of the mechanical reels have been arranged on the pay line when the mechanical reels are in a stopped state, displaying symbols inside said transparent areas of the transparent-type liquid crystal display so as to overlap the blanks;
(b-2) awarding a payout to a player based on a symbol combination that was arranged on the pay line, the symbol combination consisting of symbols which are displayed inside said transparent areas of the transparent-type liquid crystal display and symbols of the mechanical reels;
(c-1) if a predetermined number of trigger symbols, from the symbols which have been displayed inside said transparent areas of the transparent-type liquid crystal display, are arranged on the pay line, causing the trigger symbols to migrate from inside said transparent areas of the transparent-type liquid crystal display to outside said transparent areas, where they are displayed;
(c-2) displaying 2 video reels outside said transparent areas of the transparent-type liquid crystal display for identifying a rotation number of times and a payout magnification rate;
(d) displaying the video reels in a rotating manner and in a stopped manner; and
(e) conducting a free game using the mechanical reels, based on said rotation number of times and payout magnification rate that were identified by displaying the video reels in a stopped state.
